(19) United States
(12) Patent Application Publication
(10) Pub. No.: US 2001/0052023 A1
(43) Pub. Date: Dec. 13, 2001

(54) Method, apparatus, and system for using TCP/IP as the transport layer for screen phones

(76) Inventors: Chi-To Lin, Colts Neck, NJ (US); Steve Min-Chou Lin, East Brunswick, NJ (US)

Correspondence Address: BURNS DOANE SWECKER & MATHIS L L P, POST OFFICE BOX 1404, ALEXANDRIA, VA, 22313-1404, US

(21) Appl. No.: 09/796,588

(22) Filed: Feb. 28, 2001

Related U.S. Application Data
(60) Provisional application No. 60/185,633, filed on Feb. 29, 2000.

(51) Int. Cl. G06F 15/16

(52) U.S. Cl. 709/237

(57) ABSTRACT

Application information is sent from an ADSI server to an ADSI compatible device using TCP/IP. Application protocol information is encapsulated according to ADSI message layer and datalink layer protocol specifications to form a bit stream of application information. The bit stream of application information is passed to a socket interface of a TCP/IP protocol stack in the server to form a TCP/IP representation of the application information. The TCP/IP representation of the application information is sent from the ADSI server to the ADSI compatible device over a TCP/IP based network. The TCP/IP representation of the application information is received into a TCP/IP protocol stack in the ADSI compatible device. The bit stream of application information is retrieved from a socket interface of the TCP/IP protocol stack in the ADSI compatible device. The application protocol information is unencapsulated from the retrieved bit stream of application information. The unencapsulated application protocol information is then used by the ADSI device to display information on the device and to provide visual application prompts. An analogous approach is used to send response information from the ADSI device to the ADSI server.

This application claims priority from U.S. Provisional Patent Application No. 60/185,633, which was filed on Feb. 29, 2000, and which is expressly incorporated here by reference.

### BACKGROUND

This invention relates generally to a method, apparatus, and system for using TCP/IP as the transport layer for screen phones. More particularly, this invention relates to a method, apparatus, and system for using TCP/IP as the transport layer for screen phones employing an Analog Display Services Interface (ADSI) protocol.

ADSI is a telecommunications protocol promulgated by Telcordia Technologies (formerly Bellcore) that may be used to deliver applications, similar to today's interactive voice response applications, to ADSI compatible devices with the added benefit of providing a text display feature. ADSI applications are typically easy to interact with. This is because ADSI users, already very familiar with the telephony interactive voice response format, are able to navigate through application menus with the aid of both audible and visual prompts.

The ADSI protocol provides for bidirectional data communication that allows customers to use screen-based information and call management features via an ADSI compatible device. The protocol uses both high frequency voice band dual tone multi-frequency (DTMF) tones, and standard modem-based technology (Frequency Shift Keying, or FSK, modulation) to exchange information over the public telephone switched network (PSTN). This FSK modulation scheme is the same technology now used to transmit caller ID and other related call management information over the PSTN. The ADSI protocol is most commonly used in today's advanced function screen phones, but there also exist TV set-top boxes, personal data assistants (PDAs), pagers, and personal computers that are ADSI compatible.

ADSI, like many data communication protocols, is a layered protocol. FIG. 1 shows the ADSI protocol stack which comprises three layers: a physical layer 101, a datalink layer 103, and a message layer 105. The lowest layer in the ADSI protocol stack, the physical layer 101, is responsible for managing the physical interface, and for controlling the transmission of the physical data stream (or bit stream) of information over the PSTN using DTMF tones and FSK. In addition, the physical layer 101 handles both signaling information, as well as the voice information for the protocol.

The next higher layer in the ADSI protocol stack is the datalink layer 103. The ADSI datalink layer 103, like the datalink layers of other layered protocols, uses header and trailer information to ensure a reliable transfer of information is maintained. When a transmission error is detected, it is the responsibility of the datalink layer 103 to correct the error by requesting the retransmission of corrupted information.

At the highest layer of the ADSI protocol stack lies the message layer 105. It is the function of the message layer 105 to control the exchange of feature-specific information, comprising a set of pre-defined parameters. These parameters contain both the state and display information needed to run applications on an ADSI compatible device.

FIG. 2 depicts the manner by which an ADSI server 201 communicates with an ADSI compatible device 203 over the existing analog, voice-grade, circuit-switched PSTN 205. The server 201 may have a plurality of installed ADSI applications 207 for use by the various devices 203 connected to the server 201 through the network 205. These applications 207 may be used to provide services such as banking, shopping, advertising, or news services to ADSI devices 203 connected to the server 201. Application information to be sent from the server 201 to a requesting device 203 is first translated into signaling tones, voice information, and FSK data by the server ADSI protocol stack 209. This translated information 211 is then transmitted by the server 201 over the PSTN 205, where it is received by the requesting device 203. Upon receipt, the translated information 211 is then passed up the device protocol stack 209. The restored application information is then used by device specific hardware and software 213 to provide visual and audible application prompts, as well as voice information to the device users.

FIG. 3 depicts the manner by which the ADSI compatible device 203 communicates with the ADSI server 201 over the PSTN 205. This process is the companion process to the transmission scheme shown in FIG. 2. In comparing these two processes, it will readily become apparent that only the physical layer 101 of the three layer ADSI protocol stack 209 is used to transfer information from the device 203 to the server 201. That is, the application response information gathered by the device specific hardware and software 213 is directly translated into either DTMF tones or voice information by the device physical layer 101. This translated information 301 is then transmitted by the device 203 over the PSTN 205, where it is received by the application server 203. Upon receipt, the translated information 301 is then directly restored to transmitted application information by the server physical layer 101. The restored application information is then used by the ADSI application 207 to process application requests and replies sent from the device 203.

For additional information on the ADSI protocol, the reader is referred to the Telcordia technical reference TR-NWT-001273, Issue 1, December 1992, entitled “Generic Requirements for an SPCS to Customer Premises Equipment Data Interface for Analog Display Services.”

Conventionally, users access ADSI applications 207 by dialing directly into an ADSI server 201 from a device 203 using a standard telephone voice call. Each user who wishes to access an ADSI application 207 from a respective device 203 must dial in separately to the server 201. To avoid excessive toll connection charges, users must dial into a ADSI server 201 located within their local calling district. This “connection” oriented infrastructure typically creates local access problems, as multiple servers must often be installed in populous geographic regions in order to support the high demand for services in that region. Local access problems could be reduced or avoided, however, if a so-called “connectionless” infrastructure could be used to access ADSI applications. It will be understood that connectionless in this context is meant to describe a communication infrastructure that is not reliant on having dedicated, circuit-switched connections between communicating devices.

To enable ADSI application information to be exchanged between existing ADSI servers and devices without the need for dedicated connections, one must start by employing a transport protocol capable of managing the flow of information over a connectionless network infrastructure. By far, the most popular of such data protocols in use today is the TCP/IP protocol. TCP/IP is often referred to as the protocol of the Internet. This popular data protocol may be used as the basic communication language between many varied types of physical networks in both local area and wide area (LAN and WAN) network environments.

FIG. 4 shows the TCP/IP protocol stack which comprises four layers: the datalink layer 401, the network layer 403, the transport layer 405, and the application layer 407.

The lowest layer in the TCP/IP protocol stack is the datalink layer 401. The datalink layer 401, is the interface to the actual network hardware that transmits and receives the data. This interface may or may not provide reliable delivery, and may be packet or stream oriented. In fact, TCP/IP does not specify any protocol here, but can use almost any network interface available, which illustrates the flexibility of the IP layer. Examples are Ethernet (IEEE 802.2), X.25 (which is reliable in itself), ATM, and FDDI. Note that Requests for Comments (or RFCs) that define the TCP/IP standards do not actually describe or standardize any network layer protocols per se; they only standardize ways of accessing those protocols from the network layer 403.

The network layer 403 provides the “virtual network” image of a communication system (that is, this layer shields the higher levels from the physical network architecture below it). Internet Protocol (IP) is the most important protocol in this layer. It is a connectionless protocol that doesn't assume reliability from the lower layers. IP does not provide reliability, flow control or error recovery. These functions must be provided at a higher level. Part of communicating messages between network devices is a routing function that ensures that messages will be correctly delivered to their destination. IP provides this routing function. A message unit in an IP network is called an IP datagram. This is the basic unit of information transmitted across TCP/IP networks.

The next higher layer in the TCP/IP protocol stack is the transport layer 405. This layer manages the end-to-end data transfer. Multiple applications can be supported simultaneously. The transport layer 405 is responsible for providing a reliable exchange of information. The main transport layer protocol is Transmission Control Protocol (TCP). Another transport layer protocol is User Datagram Protocol (UDP), which provides a connectionless service in comparison to TCP, which provides a connection-oriented service. That means that applications using UDP as the transport protocol have to provide their own end-to-end flow control. Usually, UDP is used by applications that need a fast transport mechanism.

The top layer in the protocol stack is the application layer 407. The application layer 407 is provided by the programs that use TCP/IP for communication. The interface between the application layer 407 and transport layer 405 is defined by port numbers and sockets.

If the ADSI protocol could be made to seamlessly interact with this socket interface, then TCP/IP could be used as the transport layer for existing ADSI applications. As with TCP/IP applications (e.g., HTTP, FTP, SMTP, Telnet, Gopher), an ADSI application, using TCP/IP as its transport layer, would be shielded from the physical network architecture that exists below it. This would allow a connectionless physical network interface to be used to address the local access problem discussed above, without having to modify the library of available ADSI applications.

In addition, having a TCP/IP interface would allow ADSI applications to reside anywhere within a TCP/IP based network, including within the Internet. To access these applications, a user may employ means necessary to establish a TCP/IP based connection, including an existing Internet Service Provider (ISP) account. Once a TCP/IP based connection is established, users can conveniently access any ADSI applications that reside on the same network. Moreover, any other applications that reside on the TCP/IP based network can be accessed by an ADSI compatible device, provided the information from these non-ADSI applications is first translated into suitable ADSI message information.

### SUMMARY

It is therefore an object of the invention to enable screen phone users to access existing ADSI applications over a TCP/IP connection without requiring new, complicated equipment. It is yet another object of the invention to provide a technique for enabling screen phone users to access non-ADSI applications over a TCP/IP connection and interface with these applications in an efficient manner.

In exemplary embodiments, this and other objectives are met by a method, apparatus, and system for using TCP/IP as the transport layer for screen phones employing an ADSI protocol.

According to one aspect, application protocol information is encapsulated according to ADSI message layer and datalink layer protocol specifications to form a bit stream of application information. The bit stream of application information is passed to a socket interface of a TCP/IP protocol stack in the server to form a TCP/IP representation of the application information. The TCP/IP representation of the application information is sent from the ADSI server to the ADSI compatible device over a TCP/IP based network. The TCP/IP representation of the application information is received into a TCP/IP protocol stack in the ADSI compatible device. The bit stream of application information is retrieved from a socket interface of the TCP/IP protocol stack in the ADSI compatible device. The application protocol information is unencapsulated from the retrieved bit stream of application information. The unencapsulated application protocol information is then used by the ADSI device to display information on the device and to provide visual application prompts.

According to another aspect, application signaling tone information is encoded to form a binary representation of the application signaling information. The binary representation of the application signaling information is included in the bit stream of application information passed to the TCP/IP protocol stack in the server. Any binary application signaling information included in the retrieved bit stream of application information is decoded. The decoded application signaling information is then used to alert the ADSI device of type changes in the application information.

According to yet another aspect, the application signaling tone information is encoded by mapping each of a plurality of signaling tones included in the signaling tone information to a respective binary value, and comprises a CPE alerting signal.

According to yet another aspect, application voice information is encoded to form a binary representation of the voice information. The binary representation of the voice information is included in the bit stream of application information passed to the TCP/IP protocol stack in the server. Any binary voice information included in the retrieved bit stream of application information is decoded. The decoded voice information is then used by the ADSI device to provide audible information and application prompts.

According to yet another aspect, voice information is encoded by at least one of the steps of: converting the voice information into a TCP/IP compatible audio file format then encapsulating the converted voice information into at least one corresponding audio file; converting the voice information into a real time audio streaming format; and converting the voice information into a voice-over-IP format. The audio file format may be either a MP3 or a wave format. The voice-over-IP formatted information may be transmitted over the TCP/IP based network according to a session initialization protocol (SIP), a multimedia gateway control protocol (MGCP), or a H.323 protocol.

According to yet another aspect, response data tone information is encoded to form a binary representation of the response data information. Response signaling tone information is encoded to form a binary representation of the response signaling information. A bit stream of response information is then formed from the encoded response data tone and signaling tone information. The bit stream of response information is passed to a socket interface of a TCP/IP protocol stack in the device to form a TCP/IP representation of the response information. The TCP/IP representation of the response information is sent from the ADSI compatible device to the ADSI server over a TCP/IP based network. The TCP/IP representation of the response information is then received into a TCP/IP protocol stack in the ADSI server. The bit stream of response information is retrieved from a socket interface of the TCP/IP protocol stack in the ADSI server. Any binary response data and signaling information included in the retrieved bit stream of response information is decoded. The decoded response signaling information is used to acknowledge receipt of data sent from the ADSI server and the decoded response data information is used by the ADSI server to process application requests and replies sent from the ADSI compatible device.

According to yet another aspect, at least one web server and the ADSI server exchange application information over a second TCP/IP based network using a hypertext transfer protocol (HTTP) and a set of hypertext mark-up language (HTML) tags that are compatible with the ADSI server, and that permits the ADSI device to access additional application information from the at least one web server.

### BRIEF DESCRIPTION OF THE DRAWINGS

The features, objects, and advantages of the invention will become apparent by reading this description in conjunction with the accompanying drawings, in which like reference numerals refer to like elements and in which:

FIG. 1 illustrates an ADSI protocol stack;

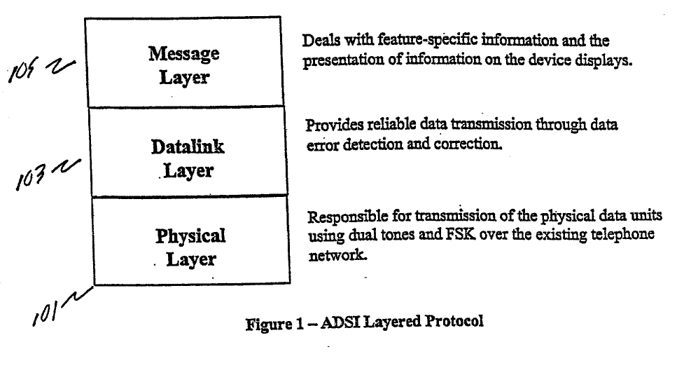

FIG. 2 illustrates a conventional manner in which an ADSI server communicates with an ADSI compatible device over the PSTN;

FIG. 3 illustrates a conventional manner in which an ADSI compatible device communicates with an ADSI server over the PSTN:

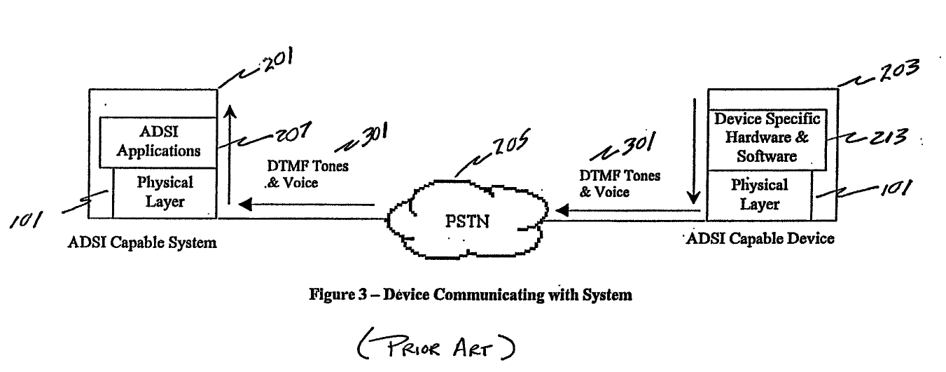

FIG. 4 illustrates a TCP/IP protocol stack;

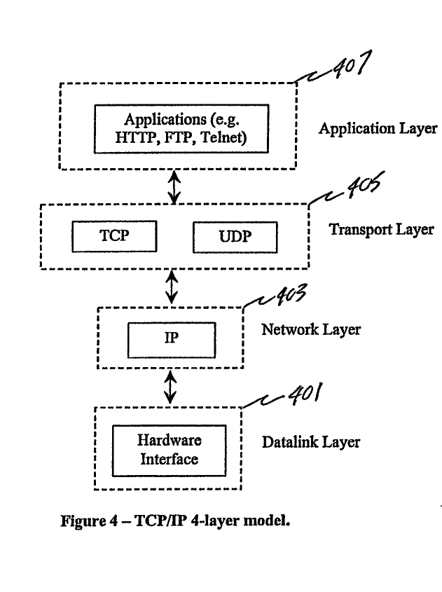

FIG. 5 illustrates a manner in which an ADSI server communicates with an ADSI compatible device using TCP/IP according to an exemplary embodiment;

FIG. 6 illustrates a manner in which ADSI application information is encapsulated in the various layers of the ADSI protocol stack;

FIG. 7 illustrates an exemplary mapping of DTMF tones;

FIG. 8 illustrates a manner in which an ADSI compatible device communicates with an ADSI server using TCP/IP according to an exemplary embodiment;

FIG. 9A illustrates a typical conventional ADSI application session;

FIG. 9B illustrates an ADSI application session using TCP/IP as the transport layer according to an exemplary embodiment; and

FIG. 10 illustrates a manner by which an ADSI compatible device communicates with a specialized ADSI server, which in turn communicates with a non-ADSI server using TCP/IP.

### DETAILED DESCRIPTION

A preferred approach to providing a connectionless physical interface through which ADSI devices can easily communicate to one another is to modify the physical layer 101 of the ADSI protocol to interact with the TCP/IP socket interface without altering the remainder of the ADSI protocol stack 209. This approach will allow the ADSI signaling and information format defined by the ADSI datalink 103 and message 105 layers to be preserved, thus avoiding having to modify the library of currently available ADSI applications. In order for ADSI servers to be able to communicate with existing ADSI devices over TCP/IP based networks, both the servers and devices will have to be capable of supporting the TCP/IP interface, including any necessary hardware and network interface changes. At the application level, the impact of these changes should be minimal, and as far as ADSI users are concerned, the services provided through the TCP/IP connection will remain as ADSI services.

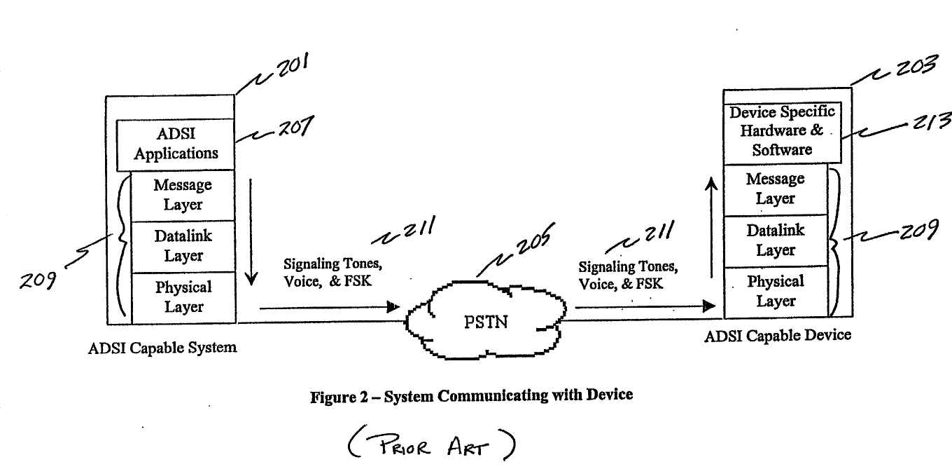

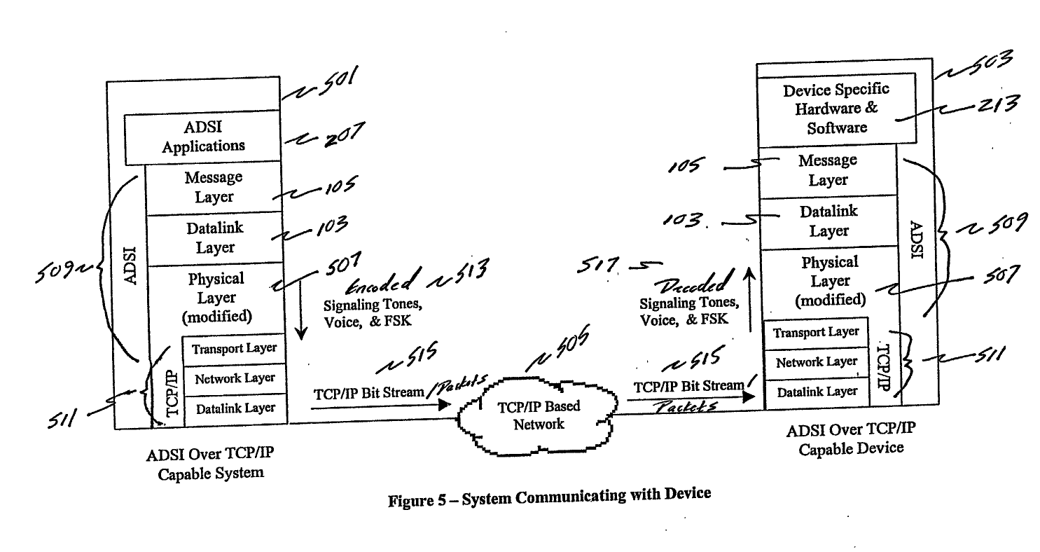

FIG. 5 depicts a manner in which a modified ADSI server 501 communicates with a modified ADSI compatible device 503 over a TCP/IP based network 505. Again, the server 501 may have a plurality of installed ADSI applications 207 for use by the various devices 503 connected to the server 501 through the network 505. As with the conventional system described in conjunction with FIG. 2, application information to be sent from the server 501 to a requesting device 503 is encapsulated as data words by the various layers of the ADSI protocol stack 509. All application information is eventually encapsulated as a bit stream by the ADSI physical layer 511.

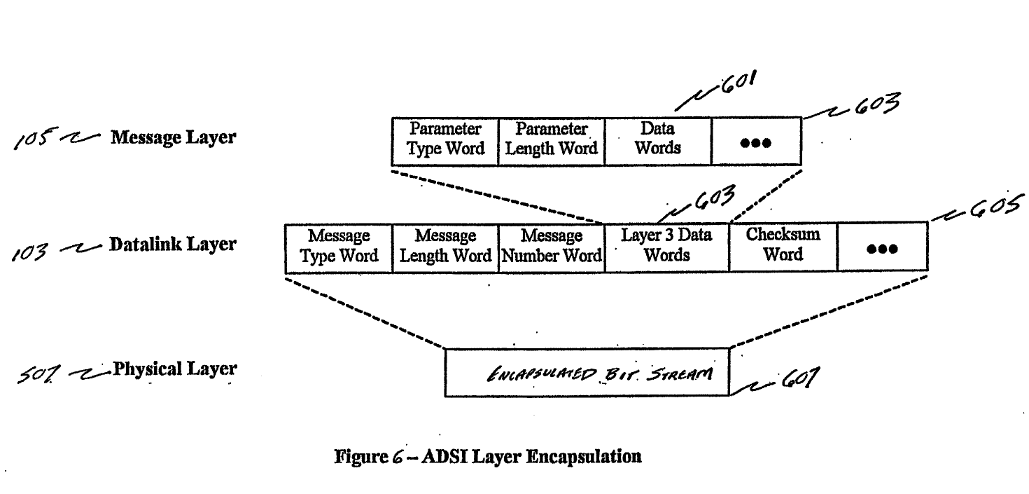

FIG. 6 depicts a typical encapsulation of information in the ADSI protocol stack 509. Data words 601 are first grouped into a plurality of ADSI parameters 603 at the message layer 105. Each ADSI parameter comprises a parameter type word, a parameter length word, and a plurality of data words 601. These ADSI parameters 603 are then combined at the datalink layer 103 to form a plurality of ADSI messages 605, each message comprising message type, length, and number words, as well as a plurality of layer three parameters, and a checksum. The header and checksum information is added at this layer to ensure that a reliable transmission of the layer three data words 601 is achieved. Information at the datalink layer 103 is then encapsulated into a bit stream 607 at the physical layer. Typically, up to five ADSI messages are encapsulated into a bit stream and then transmitted to an ADSI device before a data acknowledgment is sent to a server.

The manner in which application information is encapsulated at the both the message layer 105 and at the datalink layer 103 remains unchanged from the encapsulation method used in conventional ADSI devices. Accordingly, the existing ADSI application programming interface (API), as well as the ADSI applications themselves, can continue to be used unmodified on the ADSI devices 501/503. Furthermore, preserving the higher ADSI protocol layers preserves the abstract Customer Premises Equipment (CPE) concept. The purpose of this concept is to define a standardized “view” of the ADSI hardware interface, e.g., screens, keys, etc., such that ADSI applications can be made to easily interface with any available ADSI hardware configuration that adheres to the concept.

Although the message 105 and datalink 103 layers remain unchanged, the ADSI protocol stack 509 depicted in FIG. 5 differs from that shown in FIG. 2 in one important respect. The physical layer 507 is modified to interface with the three lowest layers of TCP/IP protocol stack 511. The types of information that pass through the ADSI physical layer 507 include application protocol, signaling, and multimedia information. The protocol information includes all ADSI application data, including protocol headers and trailers (e.g., checksums), in bit stream format. The signaling information includes all signaling tones, such as the CPE Alerting Signal (CAS) tone, and any acknowledgment tones, such as the DTMF tones. The multimedia information currently comprises voice information, but may include other media such as video, in audio and visual formats. With the modified physical layer 507, the signaling information, which was previously transmitted using DTMF tones, ADSI protocol information, which was previously transmitted using FSK, and the voice information are converted into TCP/IP application layer data 513.

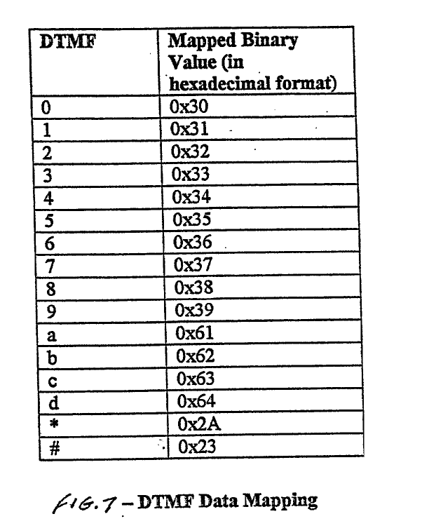

According to an exemplary embodiment, signaling information previously transmitted as DTMF tones may be digitally encoded as shown in the table of FIG. 7. This table provides an exemplary mapping of the sixteen DTMF tones available to send information from all standard telephone devices. Each of the tones is mapped to a corresponding binary value, and then transmitted as binary application data using the TCP/IP physical interface, instead of transmitting this tone information as audible tones using a tone generator. As long as this digitally encoded tone information is used to encode alphanumeric information as specified by the ADSI protocol, ADSI application that use this information will continue to function without having to be modified.

Like the signaling information, the ADSI protocol information may be mapped to the transport layer 405 of the TCP/IP protocol stack 511 for transmission over the TCP/IP network 505. This protocol information, already encapsulated at the physical layer 507 into a digital bit stream, may be directly mapped into a transport layers socket interface, instead of being transmitted using FSK modulation techniques.

The last type of ADSI information to pass through the physical layer 507, the voice information, may be digitally encoded and mapped into a binary data stream. Depending on the characteristics of the underlying TCP/IP communications infrastructure, e.g., connection speed, device capabilities, a number of existing voice communication schemes may be employed. For example, for high-speed connections, an entire voice track for an application may be encoded into a voice file, and then transmitted to a receiving device where the voice file will be played for an application user. Common formats used for this voice transmission scheme include wave and MP3 formats. Another format for sending voice information is by real time audio streaming. Existing streaming technologies, such as those from Real Networks or Microsoft, may be employed. Finally, voice information may be transmitted as voice-over-IP information according to any of the existing transfer protocols, such as H.323, SIP, or MGCP.

Having described the manner in which the various types of ADSI information may be mapped into their respective digital data streams 513, the next step in using TCP/IP as the transport layer for ADSI applications is to interface this digital information to one of the TCP/IP transport layer protocols; either TCP or UDP. A typical interface to the TCP or the UDP layer of TCP/IP is the socket interface. A socket is a special type of file handle, which is used by a process to request network services from an operating system. The socket interface is one of several APIs to the TCP/IP communication protocols. Designed to be a generic communication programming interface, the socket interface was first introduced by the 4.2BSD UNIX system. Although this interface has never been standardized, it has nevertheless become a de facto industry standard. The socket interface is differentiated by the services that are provided to applications: stream sockets (connection-oriented), datagram sockets (connectionless), and raw sockets (direct access to lower layer protocols) services.

To use TCP/IP as the transport layer, a stable TCP/IP communication link must established between the server 501 and the ADSI compatible device 503 prior to the start of any ADSI communications. The physical media over which the TCP/IP layers communicate is irrelevant to the higher ADSI layers of the combined ADSI-TCP/IP protocol stack 509/511, as long as a reliable connection can be established. Because ADSI applications are implemented as state dependent, session based programs, a reliable connection is necessary. Accordingly, it is preferable to use TCP as the default transport layer rather than UDP, as TCP provides a connection-oriented, reliable, full-duplex, byte-stream service to an application. UDP may be used under certain conditions, however, even though this protocol provides a connectionless, unreliable datagram service. For example, UDP may be used as the transport protocol when there exist adequate levels of application-based packet serialization, error detection, and support for data retransmission, in the ADSI (or non-ADSI) application. The unaltered ADSI datalink layer 103 may provide the mechanism by which this application-based error detection and correction information is exchanged.

When the encoded signaling information, voice, and protocol information 513 (or combined, the TCP/IP application layer information) has been delivered to the socket interface, this encoded information 513 is passed down the TCP/IP protocol stack 511, and transmitted over the TCP/IP based data network 505 as either bit stream or packet information 515 using any of the existing network interface schemes. Once received by the ADSI compatible device 503, the TCP/IP bit stream or packets 515 are passed up the TCP/IP protocol stack 511. The information obtained from the socket interface is then decoded by the ADSI physical layer interface 507, and passed through the standard ADSI datalink 103 and message 105 layers. Because the higher layer ADSI protocol formats remain unchanged from the original ADSI specifications, the receiving device 503 can use the same data manipulation functions used when receiving standard transmitted ADSI information to render the data. The rendered data is then used by the device specific hardware and software 213 to provide visual and audible application prompts, as well as voice information to the device users.

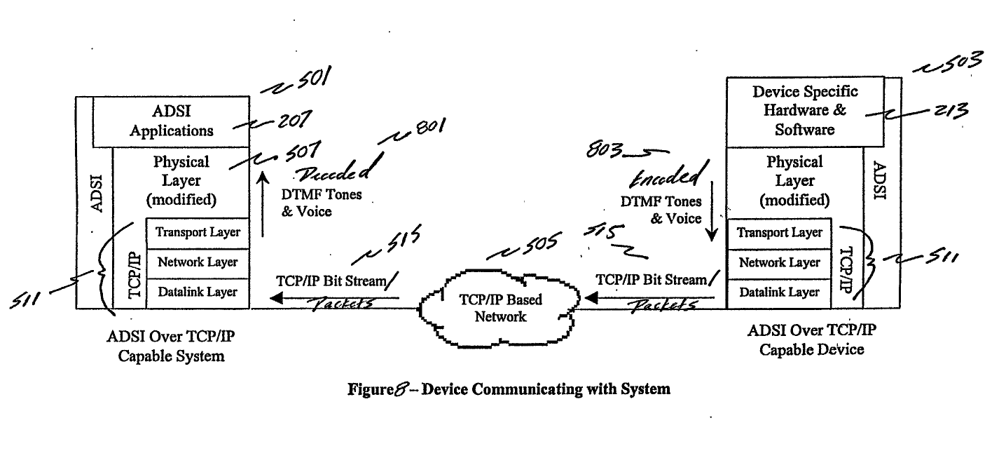

FIG. 8 depicts a manner in which the ADSI compatible device 503 communicates with the ADSI server 501 over the TCP/IP based network 505. This process is the companion process to the transmission scheme shown in FIG. 5. Again, in comparing these two processes, it will readily become apparent that only the modified physical layer 507 of the three layer ADSI protocol stack 509 and the TCP/IP protocol stack 511 are used to transfer information from the device 503 to the server 501. Again, the ADSI response data tone and signaling tone information, which were previously transmitted using encoded DTMF tones, are converted into TCP/IP application layer data 803. This TCP/IP application layer data 803 is then passed down the TCP/IP protocol stack 511, and transmitted over the TCP/IP based network 505 as either bit stream or packet information 515.

Once received by the ADSI compatible device 503, the TCP/IP bit stream or packets 515 are passed up the TCP/IP protocol stack 511. The response information obtained from the socket interface is then decoded by the ADSI physical layer interface 507. The decoded response information 801 is then used by the ADSI application 207 to process application requests and replies sent from the device 503.

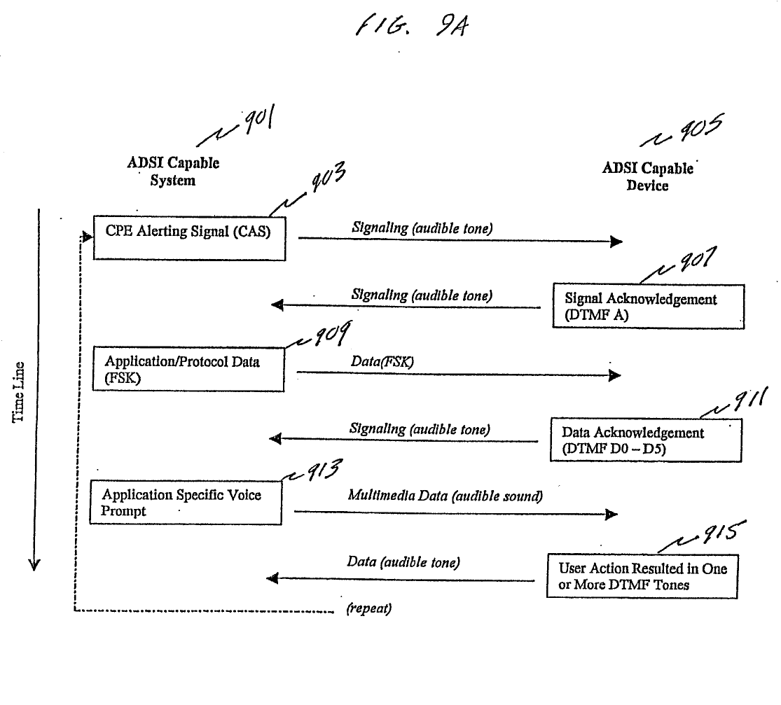

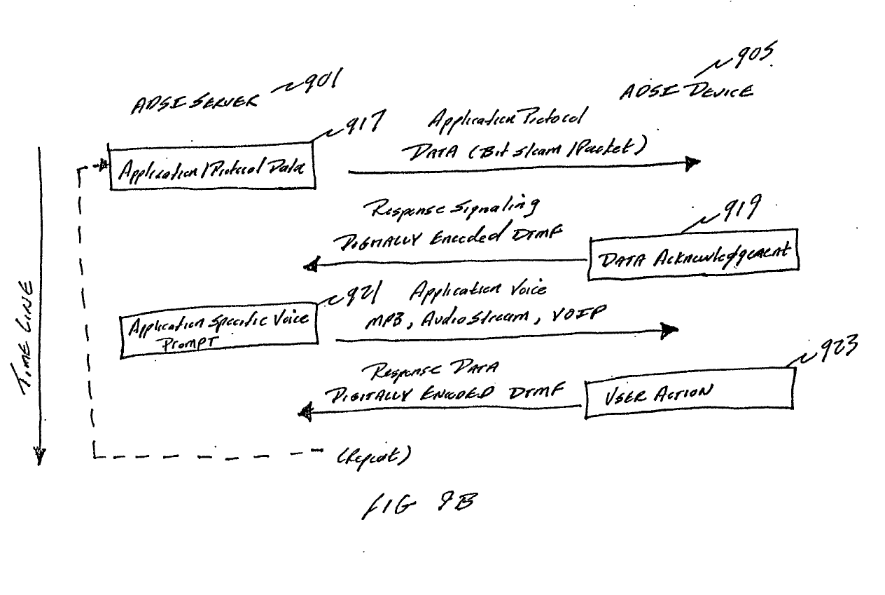

In order to facilitate a better understanding of the mapping of each category of ADSI information (signaling, voice, and protocol information), typical ADSI application sessions are illustrated in FIGS. 9A and 9B.

FIG. 9A shows a conventional ADSI voice mode session involving each of the three categories of information described above. The session begins with an ADSI server 901 sending a CAS tone 903 to an ADSI compatible device 905. This CAS tone 903 is used by an ADSI server 901 to alert an ADSI device 905 that FSK information will be forthcoming. The device may then disable its speaker to prevent the modulation from being broadcast by the receiving device 905. The CAS tone is conventionally transmitted as an audible tone. After receiving the CAS tone 903, the device 905 transmits a signal acknowledgment 907 back to the server 901 comprising a DTMF “A” tone. After receiving an acknowledgment 907, the server 901 then sends protocol information over the PSTN to the device 905 using FSK modulation techniques. Once again, the device 905 acknowledges data receipt using various DTMF tones 911. Next, application specific voice prompts 913 are sent from the server 901 to the device 905 as voice information. User responses 915 to the voice and visual prompts are then sent from the device 905 to the server 901, and the entire process repeats.

FIG. 9B depicts an ADSI application session using TCP/IP as the transport layer according to an exemplary embodiment. In a TCP/IP environment, a device should always be in a ready state to receive incoming data. Therefore, the CAS signaling tone 903 used in the conventional ADSI voice transmission is not necessary, although this signaling information may be retained. With the elimination of the CAS tone 903, the corresponding acknowledgment tone 907 from the device 905 may further be eliminated. This results in an situation similar to the ADSI data mode where the CAS tone is not used and the receiving party is always ready to receive the incoming data. Unlike conventional ADSI data mode transmission, however, application protocol information 917 is passed through the combined ADSI-TCP/IP protocol stack 509/511 and transmitted over the network 505 as either a digital bitstream or as packet information 515. Data acknowledgment is sent from the device 905 to the server in the form of digitally encoded DTMF tones, which when decoded at the server 901, are interpreted by the ADSI applications in the same manner as the conventionally received DTMF tones. Application specific voice prompts 921 may be sent from server 901 to the device 905 in any of the previously discussed formats (MP3, streaming audio format, VOIP). Again, user responses to the visual and audible prompts may be sent from the device 905 to the server 901 using digitally encoded DTMF tones, and the process repeats.

As with any communication system, there exist a number of timing requirements associated with the ADSI protocol which were put in place mainly to enable the sharing of an analog PSTN communication media among bidirectional data, signaling, and multimedia voice information in a simplex environment. These timing requirements are often quite stringent, and most of the existing timers are relatively short. With TCP/IP transmission, however, the delay due to the unreliable nature of some of the underlying communication network infrastructures is more unpredictable. Therefore, these conventional timing requirements should be relaxed when using TCP/IP as the transport layer for ADSI applications. The typical time out values used in common TCP/IP based communications should be employed in place of the conventional ADSI timing requirements.

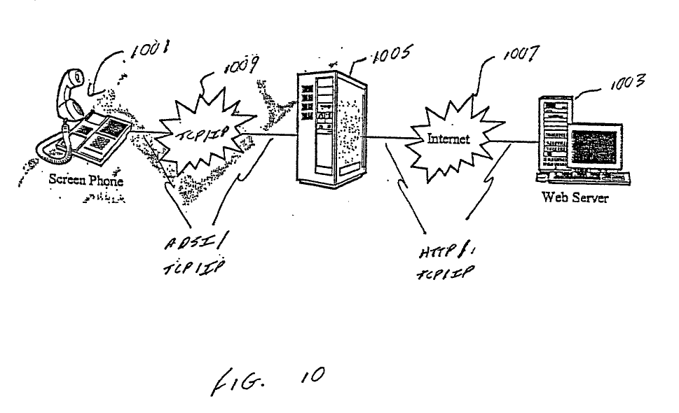

FIG. 10 is a high level overview of interaction for a screen phone with a TCP/IP based network (e.g., the Internet) via a specialized ADSI server. Such an arrangement may be used to allow ADSI compatible devices to interact with ADSI (and non-ADSI) applications over the Internet. The screen phone 1001 communicates with a web server 1003 via the specialized ADSI server 1005 and the Internet 1007 (or any other TCP/IP based network) using TCP/IP based connections 1007/1009. The screen phone 1001 accesses the specialized ADSI server 1005 through the TCP/IP network 1009 in the manner described above. Depending on the application a user wishes to run at the screen phone 1001, the specialized ADSI server 1005 establishes a standard HTTP connection through the Internet 1007 (TCP/IP network) to a corresponding specialized web server 1003. The specialized ADSI server 1005 is capable of generating requests to the web server in the same manner that a regular PC-based web browser generates requests.

The specialized ADSI server 1005 may be implemented on a suitable processor, e.g., a GLADSIS-SUNNY processor which is available from Applicant's assignee, and which has full ADSI capability to communicate with ADSI screen phones, as well as data network capability to communicate with any Internet servers. The server 1005 is further modified as described above to support using TCP/IP as its transport layer. The screen phone 1001 is of the type described above, also using TCP/IP as its transport layer.

A set of easy, clearly defined, mark-up language tags for the Internet pages are provided that are compatible with the specialized ADSI server 1005. These tags may be included in an application hosted by the web server 1003. Simple addition of these tags to the standard HTML language (HTML⁺) permits screen phones to access existing Internet pages and obtain additional information, e.g., voice and music information, controls, and advertising messages. A detailed description of a specialized ADSI server 1005 such as the one described above is provided in copending U.S. Non-Provisional Patent Application No. 09/658,105, which was filed on Sep. 8, 2000, and which is expressly incorporated here by reference.

A benefit to the above-described approach of using TCP/IP as the transport layer in ADSI based devices is to allow existing ADSI CPE manufacturers to easily, cheaply, and rapidly incorporate this new technology into their existing ADSI CPEs. Preservation of the higher ADSI protocol layers allows existing ADSI applications to be seamlessly migrated to make use of this new technology. Moreover, using TCP/IP as the transport layer in ADSI based devices will allow the present analog, PSTN-based, simplex, bidirectional sending of data and signaling tones to be easily replaced with a more robust and flexible digital media where duplex bi-direction sending of data and signaling tones is possible.

It should be emphasized that the terms “comprises” and “comprising”, when used in this specification as well as the claims, are taken to specify the presence of stated features, integers, steps or components; but the use of these terms does not preclude the presence or addition of one or more other features, integers, steps, components or groups thereof.

The various aspects of the invention have been described in connection with a number of exemplary embodiments. To facilitate an understanding of the invention, many aspects of the invention were described in terms of sequences of actions that may be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

The invention has been described with reference to particular embodiments. However, it will be readily apparent to those skilled in the art that it is possible to embody the invention in specific forms other than those of the preferred embodiments described above. This may be done without departing from the spirit of the invention. The preferred embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method for sending application information from an ADSI server to an ADSI compatible device using TCP/IP, the method comprising the steps of:
encapsulating application protocol information according to ADSI message layer and datalink layer protocol specifications to form a bit stream of application information;
passing the bit stream of application information to a socket interface of a TCP/IP protocol stack in the server to form a TCP/IP representation of the application information;
sending the TCP/IP representation of the application information from the ADSI server to the ADSI compatible device over a TCP/IP based network;
receiving the TCP/IP representation of the application information into a TCP/IP protocol stack in the ADSI compatible device;
retrieving the bit stream of application information from a socket interface of the TCP/IP protocol stack in the ADSI compatible device; and
unencapsulating the application protocol information from the retrieved bit stream of application information, wherein the unencapsulated application protocol information is used by the ADSI device to display information on the device and to provide visual application prompts.

2. The method of claim 1, further comprising the steps of:
encoding application signaling tone information to form a binary representation of the application signaling information;
including the binary representation of the application signaling information in the bit stream of application information passed to the TCP/IP protocol stack in the server; and
decoding any binary application signaling information included in the retrieved bit stream of application information, wherein the decoded application signaling information is used to alert the ADSI device of type changes in the application information.

3. The method of claim 2, wherein the application signaling tone information is encoded by mapping each of a plurality of signaling tones included in the signaling tone information to a respective binary value.

4. The method of claim 2, wherein the application signaling tone information comprises a CPE alerting signal.

5. The method of claim 1, further comprising the steps of:
encoding application voice information to form a binary representation of the voice information;
including the binary representation of the voice information in the bit stream of application information passed to the TCP/IP protocol stack in the server; and
decoding any binary voice information included in the retrieved bit stream of application information, wherein the decoded voice information is used by the ADSI device to provide audible information and application prompts.

6. The method of claim 5, wherein the step of encoding the application voice information comprises at least one of the steps of:
converting the voice information into a TCP/IP compatible audio file format then encapsulating the converted voice information into at least one corresponding audio file;
converting the voice information into a real time audio streaming format; and
converting the voice information into a voice-over-IP format.

7. The method of claim 6, wherein the audio file format is one of a MP3 and a wave format.

8. The method of claim 6, wherein the voice-over-IP formatted information may be transmitted over the TCP/IP based network according to a session initialization protocol (SIP), a multimedia gateway control protocol (MGCP), or a H.323 protocol.

9. The method of claim 1, wherein the socket interface is a transmission control protocol (TCP) socket.

10. The method of claim 1, wherein the TCP/IP representation of the application information is sent in one of a packet and bit stream format.

11. The method of claim 1, wherein the application information originates from applications stored on the ADSI server.

12. The method of claim 1, wherein the application information originates, at least partially from applications stored on at least one web server coupled to the ADSI server by a second TCP/IP based network.

13. The method of claim 12, wherein the at least one web server and ADSI server exchange application information over the second TCP/IP based network using a hypertext transfer protocol (HTTP) and a set of hypertext mark-up language (HTML) tags that are compatible with the ADSI server, and that permits the ADSI device to access additional application information from the at least one web server.

14. A method for sending response information from an ADSI compatible device to an ADSI server using TCP/IP, the method comprising the steps of:
encoding response data tone information to form a binary representation of the response data information;
encoding response signaling tone information to form a binary representation of the response signaling information;
forming a bit stream of response information from the encoded response data tone and signaling tone information;
passing the bit stream of response information to a socket interface of a TCP/IP protocol stack in the device to form a TCP/IP representation of the response information;
sending the TCP/IP representation of the response information from the ADSI compatible device to the ADSI server over a TCP/IP based network;
receiving the TCP/IP representation of the response information into a TCP/IP protocol stack in the ADSI server;
retrieving the bit stream of response information from a socket interface of the TCP/IP protocol stack in the ADSI server; and
decoding any binary response data and signaling information included in the retrieved bit stream of response information, wherein the decoded response signaling information is used to acknowledge receipt of data sent from the ADSI server and the decoded response data information is used by the ADSI server process application requests and replies sent from the ADSI compatible device.

15. The method of claim 14, wherein the response signaling tone information is encoded by mapping each of a plurality of signaling tones included in the signaling tone information to a respective binary value.

16. The method of claim 14, wherein the response signaling tone information comprises a CPE alerting signal acknowledgment.

17. The method of claim 14, wherein the socket interface is a transmission control protocol (TCP) socket.

18. The method of claim 14, wherein the TCP/IP representation of the response information is sent in one of a packet and bit stream format.

19. An ADSI server for sending application information and receiving response information, comprising:
logic that encapsulates application protocol information according to ADSI message layer and datalink layer protocol specifications to form a bit stream of application information;
logic that encodes application signaling tone information to form a binary representation of the application signaling information;
logic that encodes application voice information to form a binary representation of the application voice information;
logic that includes the binary representation of the application signaling and voice information in the bit stream of application information;
logic that passes the bit stream of application information to a socket interface of a TCP/IP protocol stack in the server to form a TCP/IP representation of the application information;
a transmitter for sending the TCP/IP representation of the application information from the ADSI server to an ADSI compatible device over a TCP/IP based network;
a receiver for receiving a TCP/IP representation of response information sent from the ADSI compatible device into the TCP/IP protocol stack;
logic that retrieves the bit stream of response information from the socket interface of the TCP/IP protocol stack; and
logic that decodes any binary response data and signaling information included in the retrieved bit stream of response information, wherein the decode response signaling information is used to acknowledge receipt of data sent from the ADSI server and the decoded response data information is used by the ADSI server to process application requests and replies sent from the ADSI compatible device.

20. The ADSI server of claim 19, wherein the application signaling tone information is encoded by mapping each of a plurality of signaling tones included in the signaling tone information to a respective binary value.

21. The ADSI server of claim 19, wherein the application signaling tone information comprises a CPE alerting signal.

22. The ADSI server of claim 19, wherein the logic that encodes the application voice information comprises at least one of:
logic that converts the voice information into a TCP/IP compatible audio file format then encapsulating the converted voice information into at least one corresponding audio file;
logic that converts the voice information into a real time audio streaming format; and
logic that converts the voice information into a voice-over-IP format.

23. The ADSI server of claim 22, wherein the audio file format is one of a MP3 and a wave format.

24. The ADSI server of claim 22, wherein the voice-over-IP formatted information may be transmitted over the TCP/IP based network according to a session initialization protocol (SIP), a multimedia gateway control protocol (MGCP), or a H.323 protocol.

25. The ADSI server of claim 19, wherein the socket interface is a transmission control protocol (TCP) socket.

26. The ADSI server of claim 19, wherein both the TCP/IP representation of the application and response information is sent in one of a packet and bit stream format.

27. The ADSI server of claim 19, wherein the application information originates from applications stored on the ADSI server.

28. The ADSI server of claim 19, wherein the application information originates, at least partially from applications stored on at least one web server coupled to the ADSI server by a second TCP/IP based network.

29. The ADSI server of claim 28, wherein the at least one web server and ADSI server exchange application information over the second TCP/IP based network using a hypertext transfer protocol (HTTP) and a set of hypertext mark-up language (HTML) tags that are compatible with the ADSI server, and that permits the ADSI device to access additional application information from the at least one web server.

30. An ADSI compatible device for sending responding and receiving application information, comprising:
logic that encodes response data tone information to form a binary representation of the response data information;
logic that encodes response signaling tone information to form a binary representation of the response signaling information;
logic that forms a bit stream of response information from the encoded response data tone and signaling tone information;
logic that passes the bit stream of response information to a socket interface of a TCP/IP protocol stack in the device to form a TCP/IP representation of the response information;
a transmitter for sending the TCP/IP representation of the response information from the ADSI compatible device to an ADSI server over a TCP/IP based network;
a receiver for receiving a TCP/IP representation of application information sent from the ADSI server into the TCP/IP protocol stack;
logic that retrieves the bit stream of application information from the socket interface of the TCP/IP protocol stack;
logic that unencapsulates the application protocol information from the retrieved bit stream of application information; and
logic that decodes any application binary signaling and voice information included in the retrieved bit stream of application information, wherein the decoded application signaling information is used to alert the ADSI device of type changes in the application information, the application voice information is used by the ADSI device to provide audible information and application prompts, and the unencapsulated application protocol information is used by the ADSI device to display information on the device and to provide visual application prompts.

31. The ADSI device of claim 30, wherein the response signaling tone information is encoded by mapping each of a plurality of signaling tones included in the signaling tone information to a respective binary value.

32. The ADSI device of claim 30, wherein the response signaling tone information comprises a CPE alerting signal acknowledgment.

33. The ADSI device of claim 30, wherein the socket interface is a transmission control protocol (TCP) socket.

34. The ADSI device of claim 30, wherein both the TCP/IP representation of the response and application information is sent in one of a packet and bit stream format.

35. A system for exchanging application and response information using TCP/IP, comprising:
at least one ADSI server including
logic that encapsulates application protocol information according to ADSI message layer and datalink layer protocol specifications to form a bit stream of application information;
logic that encodes application signaling tone information to form a binary representation of the application signaling information;
logic that encodes application voice information to form a binary representation of the application voice information;
logic that includes the binary representation of the application signaling and voice information in the bit stream of application information;
logic that passes the bit stream of application information to a socket interface of a server TCP/IP protocol stack to form a TCP/IP representation of the application information;
a transmitter for sending the TCP/IP representation of the application information over a TCP/IP based network;
a receiver for receiving a TCP/IP representation of response information sent over the TCP/IP based network into the server TCP/IP protocol stack;
logic that retrieves the bit stream of response information from the socket interface of the server TCP/IP protocol stack; and
logic that decodes any binary response data and signaling information included in the retrieved bit stream of response information; and
at least one ADSI compatible device, coupled to the at least one ADSI server through the TCP/IP based network, the at least one ADSI compatible device including
logic that encodes response data tone information to form a binary representation of the response data information;
logic that encodes response signaling tone information to form a binary representation of the response signaling information;
logic that forms a bit stream of response information from the encoded response data tone and signaling tone information;
logic that passes the bit stream of response information to a socket interface of a device TCP/IP protocol stack to form a TCP/IP representation of the response information;
a transmitter for sending the TCP/IP representation of the response information from the at least one ADSI compatible device to the at least one ADSI server over the TCP/IP based network;
a receiver for receiving the TCP/IP representation of application information sent from the at least one ADSI server into the device TCP/IP protocol stack;
logic that retrieves the bit stream of application information from the socket interface of the device TCP/IP protocol stack;
logic that unencapsulates the application protocol information from the retrieved bit stream of application information; and
logic that decodes any application binary signaling and voice information included in the retrieved bit stream of application information;
wherein the decoded application signaling information is used to alert the at least one ADSI device of type changes in the application information, the application voice information is used by the at least one ADSI device to provide audible information and application prompts, the unencapsulated application protocol information is used by the at least one ADSI device to display information on the device and to provide visual application prompts, the decoded response signaling information is used to acknowledge receipt of data sent from the at least one ADSI server, and the decoded response data information is used by the at least one ADSI server to process application requests and replies sent from the at least one ADSI compatible device.

36. The system of claim 35, wherein the application information originates from applications stored on the at least one ADSI server.

37. The method of claim 35, further comprising:
at least one web server coupled to the at least one ADSI server over a second TCP/IP based network for exchanging application information at least partially from applications stored on the at least one web server using a hypertext transfer protocol (HTTP) and a set of hypertext mark-up language (HTML) tags that are compatible with the at least one ADSI server, and that permits the at least one ADSI device to access additional application information from the at least one web server.
